(19) United States
(12) Patent Application Publication
(10) Pub. No.: US 2024/0010104 A1
(43) Pub. Date: Jan. 11, 2024

(54) Temperature Control Device for Controlling the Temperature of a Cell Block, of an Electrical Energy Store, as Well as a Method

(71) Applicant: Mercedes-Benz Group AG, Stuttgart (DE)

(72) Inventors: Patrick WITTMANN, Stuttgart (DE); Alexander LUECK, Ludwigsburg (DE); Dominik MAYER, Fellbach (DE); Meike KOLLMANNTHALER, Ditzingen (DE); Giuseppe DI LELLA, Tamm (DE)

(21) Appl. No.: 18/255,258

(22) PCT Filed: Nov. 16, 2021
(86) PCT No.: PCT/EP2021/081836

§ 371 Date: May 31, 2023

(30) Foreign Application Priority Data
Dec. 7, 2020 (DE) 10 2020 007 429.4

(51) Int. Cl. B60L 58/32; B60L 50/64

(52) U.S. Cl. CPC B60L 58/32; B60L 50/64

(57) ABSTRACT

A temperature control device for controlling a temperature of a cell block of an electrical energy store. A temperature control fluid is guided in a temperature control channel for controlling the temperature of the cell block where the temperature control channel has a changing cross-section viewed in a direction of flow of the temperature control fluid and where a plurality of battery cells of the cell block are disposed next to each other at least in areas viewed in the direction of flow. The temperature control fluid directly controls the temperature of the cell block, the temperature control channel tapers in the direction of flow from a first battery cell of the plurality of battery cells to a predetermined section of the temperature control channel, and the temperature control channel widens after the predetermined section.

### BACKGROUND AND SUMMARY OF THE INVENTION

The invention relates to a temperature control device for controlling the temperature of a cell block of an electrical energy store. The invention further relates to a method for controlling the temperature of a cell block.

Battery cells, for example lithium ion battery cells, operate expediently within a certain operating range. In order to achieve this operating range, which here in particular represents a temperature control range, temperature control devices are known which can release or supply thermal energy, whereby the temperature-dependent current limitation and the thermal storage capacity of the cell block are increased. Different possibilities for controlling temperature are known. For example, a cooling plate with a cooling device can be formed on an underside of a cell block, wherein the cooling device is cooled on the basis of a fluid and the thermal energy can thus be released into the cooling fluid.

DE102018006412A1 relates to a temperature control unit for a battery, comprising at least one channel that is flowed through and can be flowed through by a temperature control medium. The channel has at least one cross-section that changes in the direction of flow.

It is the object of the present invention to provide a temperature control device as well as a method by means of which a more efficient temperature control of a cell block of an electrical energy store can be realized.

One aspect of the invention relates to a temperature control device for controlling the temperature of a cell block of an electrical energy store, having at least one temperature control fluid which is guided in a temperature control channel for controlling the temperature of the cell block, wherein the temperature control channel has a changing cross-section viewed in a direction of flow of the temperature control fluid, and wherein a plurality of battery cells of the cell block are arranged next to each other at least in areas viewed in the direction of flow.

It is provided that the temperature control fluid is designed for directly controlling the temperature of the cell block, and the temperature control channel tapers in the direction of flow from a first battery cell of the battery cells arranged next to each other to a predetermined section of the temperature control channel and the temperature control channel widens again after the predetermined section.

A consistent cooling of the cell block can thus be realized with the plurality of battery cells. This allows a maximum usage of the temperature-dependent current limit and the thermal storage capacity of the cell block, whereby the continuous output can in particular be increased. In particular, the invention thus solves that problem that, by means of heating the fluid in the flow-through direction of a cell module, an uneven cooling can occur. Cells at the coolant inlet are cold and cells at the coolant outlet are warm. This leads to a poor usage of the thermal storage capacity of the battery cells, since the hottest battery cell is in particular limiting. By means of the local adjustment of the flow cross-section, a targeted reduction of hot and cold spots can be realized. An improved uniform distribution of the temperature can thus be realized, whereby the output can be increased and, in particular, the dissipation reduction within the module can be improved and the ageing mechanisms can be reduced.

In the cell block it can in particular be provided that the individual battery cells arranged next to each other can be connected both in parallel and in series. These can be flowed around both radially next to each other and also axially next to each other.

In particular, both a cooling of the battery cells and also a heating of the battery cells can be carried out by means of the temperature control device. For example, a cooling can be carried out during the operation of the battery cells, so that these are cooled to a predetermined temperature value. For example, before starting a motor vehicle it is advantageous if the batteries are quickly brought to an operating temperature, so that it is advantageous here if these are heated. Both a warming and also a cooling can thus be carried out by means of the temperature control device.

According to an advantageous embodiment, the temperature control channel is formed between a sealing plane on the battery cells, which is formed substantially in the direction of flow, and a housing wall of a housing of the electrical energy store. The sealing plane is in particular formed on the cell walls of the battery cells. In particular, the battery cells are located in an interior of the housing. The sealing plane in particular fluidically separates two cooling planes from each other, for example a base cooling and a top cooling. By means of the sealing plane, both a base cooling and also a top cooling of the battery cells can thus be realized.

It is furthermore advantageous if the changing cross-section of the temperature control channel is formed on the housing wall. In particular, the housing wall, which can also be referred to as the module housing wall, can thus have the corresponding cross-section changes, so that the uniformity of the cooling can be improved. In particular, the cooled surface of each cell remains constant during the base cooling or the top cooling.

It has further been shown to be advantageous if the temperature control channel is formed in an interior in a sealing plane on the battery cells, which is formed substantially in the direction of flow. The sealing plane can thereby for example be formed as a cylinder and be hollow in the interior, so that the temperature control fluid can flow through the interior. A sheath cooling can thus, for example, be realized by the sealing plane.

In a further advantageous embodiment, the sealing plane has a first sealing wall and a second sealing wall opposite this, wherein the first sealing wall and the second sealing wall are formed substantially in the direction of flow, and the changing cross-section is formed on at least one of the sealing walls. In particular, the sealing plane is thus formed as a hollow cylinder and at least one of the sealing walls has the changing cross-section. An improved uniformity of the cooling of the battery cells can thus be realized in the interior of the sealing plane.

It is also advantageous if the changing cross-section is formed on both sealing walls. A further improvement of the temperature uniformity within the interior of the sealing plane can thus be realized. This can thus result in increased efficiency of the cell block.

According to a further advantageous embodiment, the predetermined section is formed on the battery cells formed next to each other, viewed substantially centrally in the direction of flow. In other words, the tapering of the temperature control channel is formed up to a middle of the temperature control channel. In particular, the temperature control channel thus tapers, viewed in the direction of flow. A narrowing thus occurs at a so-called cold spot. Approximately after the middle, viewed in the direction of flow, the temperature control channel then in turn expands. In particular, an expansion of the temperature control channel can thus in turn be realized, viewed in the direction of a hot spot. An improved uniformity of the cooling can thus be realized.

It has further been shown to be advantageous if the temperature control device is formed for carrying out sheath temperature control and/or top temperature control and/or base temperature control. In a preferred embodiment, the temperature control device is formed for carrying out sheath temperature control, top temperature control and base temperature control. For example, the top temperature control and the base temperature control can form an outflow of the temperature control fluid and, by means of the sheath temperature control, the return can then in turn be formed. An advantageous temperature control of the battery cells can thus be realized.

It has further been shown to be advantageous if the battery cell is formed as a prismatic battery cell and/or cylindrical battery cell and/or as a pouch cell. Different types of battery cells can thus be temperature-controlled by means of the temperature control device. As a result, the temperature control device can be used in a very versatile manner.

A further aspect of the invention relates to an electrical energy store with a temperature control device according to the preceding aspect.

Yet another further aspect of the invention relates to a motor vehicle with an electrical energy store according to the preceding aspect. The motor vehicle is in particular at least partially electric, in particular completely electric.

Yet another further aspect of the invention relates to a method for controlling the temperature of a cell block of an electrical energy store by means of a temperature control device, having at least one temperature control fluid which is guided in a temperature control channel for controlling the temperature of the cell block, wherein the temperature control channel has a changing cross-section viewed in a direction of flow of the temperature control fluid, and wherein a plurality of battery cells of the cell block are arranged next to each other at least in areas viewed in the direction of flow.

It is provided that, by means of the temperature control fluid, the cell block is directly cooled, wherein the temperature control channel tapers in the direction of flow from a first battery cell of the battery cells arranged next to each other to a predetermined section of the temperature control channel and the temperature control channel widens again after the predetermined section.

Advantageous embodiments of the temperature control device are to be seen as advantageous embodiments of the electrical energy store, of the motor vehicle, as well as of the method. To this end, the temperature control device, the electrical energy store as well as the motor vehicle have subject-matter features, which are necessary for carrying out the method.

Further advantages, features and details of the invention result from the description of preferred exemplary embodiments below, as well as by means of the drawings. The features and feature combinations referred to in the description above, as well as the features and feature combinations referred to below in the description of the figures and/or shown solely in the figures can be used not only in the respectively specified combinations, but also in other combinations or alone, without leaving the scope of the invention.

### BRIEF DESCRIPTION OF THE DRAWINGS

FIG. 1 shows a schematic plan view of an embodiment of a motor vehicle with an embodiment of an electrical energy store with an embodiment of a temperature control device;

FIG. 2 shows a schematic plan view of a further embodiment of an electrical energy store with an embodiment of a temperature control device; and

FIG. 3 shows a further schematic plan view of an embodiment of an electrical energy store with an embodiment of a temperature control device.

### DETAILED DESCRIPTION OF THE DRAWINGS

In the figures, the same or functionally identical elements are provided with the same reference numerals.

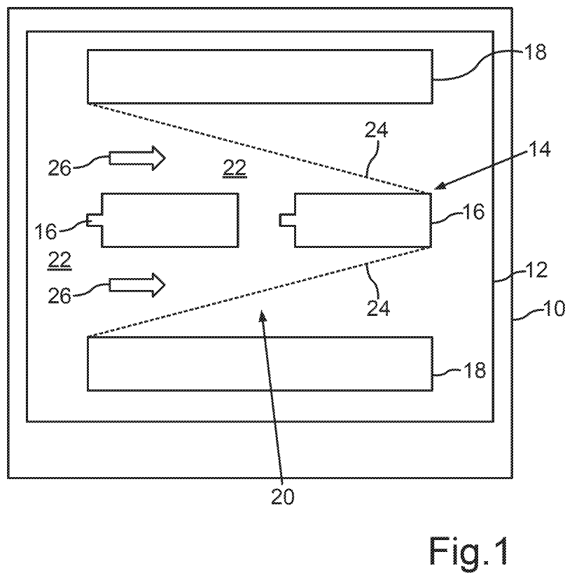

FIG. 1 shows an embodiment of a motor vehicle 10 in a schematic plan view. The motor vehicle 10 is in particular at least partially electrically operated. In particular, the motor vehicle 10 is completely electrically operated. The motor vehicle 10 has an electrical energy store 12. The electrical energy store 12 in turn has at least one cell block 14. In the present exemplary embodiment, the cell block 14 has two battery cells 16, which are arranged next to each other. In particular, the battery cells 16 are arranged axially next to each other in the present exemplary embodiment.

The cell block 14 has a housing, the presence of which is shown in particular by means of two housing walls 18. Further, the cell block 14 has a temperature control device 20. The temperature control device 20 can be formed in this case for both cooling and also for heating the battery cells 16.

The temperature control device 20 is formed for controlling the temperature of the cell block 14 of the electrical energy store 12 and, to this end, has at least one temperature control fluid 22 which is guided int a temperature control channel 24 for controlling the temperature of the cell block 14, wherein the temperature control channel 24 has a changing cross-section viewed in a direction of flow 26 of the temperature control fluid 22, and wherein a plurality of battery cells 16 of the cell block 14 are arranged next to each other at least in areas viewed in the direction of flow 26.

The temperature control fluid 22 is designed for directly controlling the temperature of the cell block 14, and the temperature control channel 24 tapers in the direction of flow 26 from a first battery cell 16 to a predetermined section 28 of the temperature control channel 24, wherein the temperature control channel 24 widens again after the predetermined section 28.

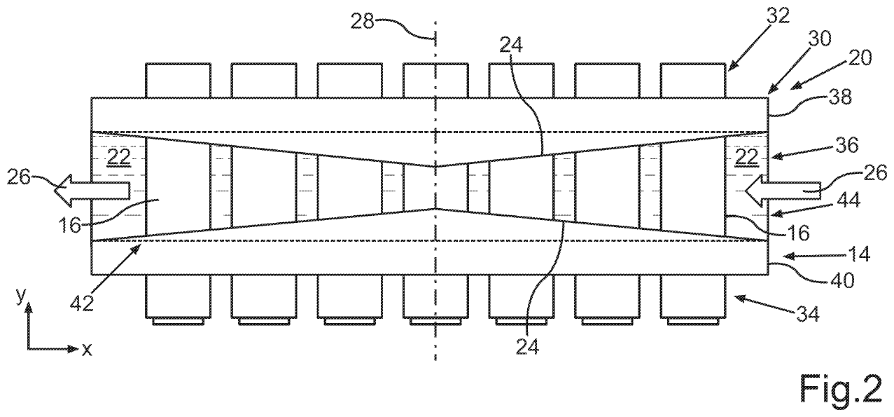

FIG. 2 shows a schematic plan view of a further embodiment of the temperature control device 20. In the present exemplary embodiment, an x/y plane is in particular shown. The cooling fluid 22 in particular moves with the direction of flow 26, here counter to the x direction. The cell block 14 has seven battery cells 16 formed next to each other in this exemplary embodiment. The battery cells 16 are, in turn, fluidically separated from a cell base 32 and a cell top 34 by a sealing plane 30, so that a cell centre 36 of each battery cell 16 has its temperature controlled here.

In the present exemplary embodiment, the sealing plane 30 has a first sealing wall 38 as well as a second sealing wall 40, wherein the first sealing wall 38 and the second sealing wall 40 are formed opposite from each other.

Here, the first battery cell 16 is formed at a temperature control fluid inlet 44.

In FIG. 2 it is in particular shown that the temperature control channel 24 is formed in an interior in the sealing plane 30 on the battery cells 16, which is formed substantially in the direction of flow 26. Here, the sealing plane 30 in particular has a first sealing wall 38 and a second sealing wall 40 opposite this, wherein the first sealing wall 38 and the second sealing wall 40 are formed substantially in the direction of flow 26, and the changing cross-section is formed on at least one of the sealing walls 38, 40. Here, it is in particular shown that the changing cross-section is formed on both sealing walls 38, 40. In particular, the changing cross-section is here shown by h(x). In particular, a height of the temperature control channel 24 is thus changed. In the present exemplary embodiment it is further shown that both the first sealing wall 38 as well as the second sealing wall 40 have corresponding slopes for achieving the different heights. The first slope of the first sealing wall 38 is shown by a(x) and the second slope of the second sealing wall 40 is shown by b(x).

Here, the local cross-section change can in particular be realized by means of a sheath cooling. In particular, the uniformity of the cooling can thus by optimized, wherein it is in particular carried out by a corresponding choice of h(x) over a(x) and b(x). Here, it can in particular be provided that an expansion of the temperature control channel 24 is achieved at a hot spot, which is here in particular at the end of the cell block 14 when viewed in the direction of flow 26, which is described by means of the reference numeral 42. By means of the reference numeral 44, a temperature control fluid inlet is in particular shown, wherein a cold spot hereby arises. It is now provided that a narrowing develops at a cold spot, which is in particular carried out by means of the tapering. In the present exemplary embodiment, the cooled surface of each battery cell 16 is in particular dependent on h(x). Via a(x), b(x), hot spots or cold spots can thus be reduced below and above the respective battery cells 16. It is in particular provided that the heat flow \dot{Q}(x) is proportional to the heat transfer coefficients α and the cooled surface A_{z}(x). This is, in turn, proportional to a product of the square root of the Reynolds number as well as the height h(x). This is, in turn, proportional to a product of the height h(x) and the square root of the flow rate. This is, in turn, proportional to the square root of 1 by the height h(x), multiplied by the height h(x), wherein it then, in turn, emerges as the result that the heat transfer \dot{Q}(x) is the same as the square root of h(x).

FIG. 2 further shows that the predetermined section 28 is formed on the battery cells 16 formed next to each other, viewed substantially centrally in the direction of flow 26. Here, the temperature control device 20 is in particular formed for carrying out a sheath temperature control. Additionally or instead, the temperature control device 20 can also be formed for a top temperature control and/or a base temperature control.

It is further in particular shown that the battery cell 16 is formed as a prismatic battery cell and/or as a cylindrical battery cell and/or as a pouch cell.

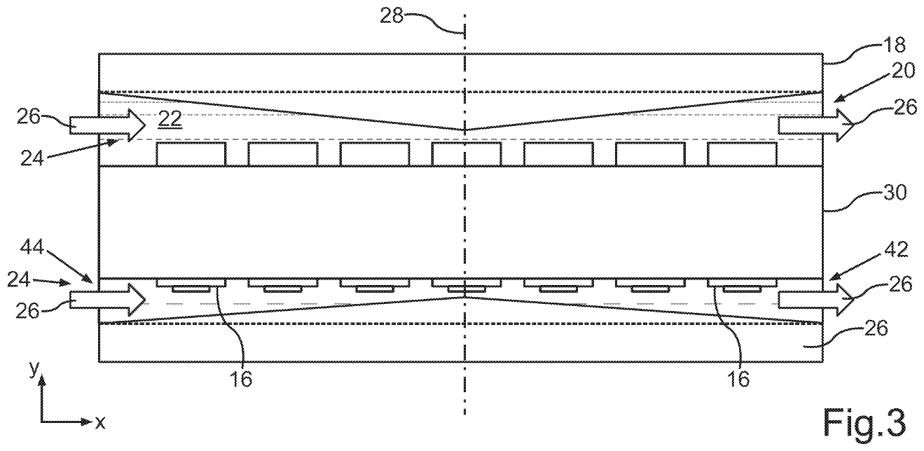

FIG. 3 shows a further schematic plan view of a further embodiment of a temperature control device 20. In the following embodiment, a top cooling and/or base cooling is in particular shown. In the following exemplary embodiment it is in particular shown that the temperature control channel 24 is formed between the sealing plane 30 on the battery cells 16, which is formed substantially in the direction of flow 26, and housing walls 18 of the housing of the electrical energy store 12. The changing cross-section of the temperature control channel 24 is in particular formed on the housing wall 18. It is in particular shown here that the changing cross-section of the temperature control channel 24 is formed on both housing walls 18. In FIG. 3, a base cooling as well as a top cooling is in particular shown.

It is in particular shown that, for achieving temperature control, a symmetrical profile is in particular formed for the temperature control channel 24.

In the following exemplary embodiment, the heat flow \dot{Q}(x) is in particular proportional to the heat transfer coefficients α and to the cooled surface A_{z}. This is, in turn, proportional to a product of the square root of the Reynolds number and the cooled surface A_{z}. This is, in turn, proportional to a product of the square root of the flow rate and the cooled surface A_{z}. This is, in turn, proportional to the square root of 1 by h(x) multiplied by the cooled area A_{z}. During the base cooling or the top cooling, the optimization of the uniformity of the cooling is thus enabled by means of a strategic selection of the height h(x). The cooled surface of the battery cell 16 is preferably constant.

It can in particular be provided that, in a preferred embodiment, both a sheath cooling, as is described in FIG. 2, and also a top and/or base cooling, as is described in FIG. 3, is provided. To this end, the sealing plane 30 can then, for example, in turn be formed as in FIG. 2 with the first sealing wall 38 and the second sealing wall 40, wherein it can then in turn in particular be provided that the top cooling and/or base cooling serve as inflows of the temperature control fluid 22 and the return of the temperature control fluid 22 inside the sealing plane 30 is realized.

The invention also relates to a method for controlling the temperature of the cell block 14 of the electrical energy store 12 by means of the temperature control device 20, having at least the temperature control fluid 22 which is guided in the temperature control channel 24 for controlling the temperature of the cell block 14, wherein the temperature control channel 24 has a changing cross-section viewed in the direction of flow 26 of the temperature control fluid 22, and wherein a plurality of battery cells 16 of the cell block 14 are arranged next to each other at least in areas. It is thereby provided that, by means of the temperature control fluid 22, the cell block 14 is directly cooled, wherein the temperature control channel 24 tapers in the direction of flow 26 from a first battery cell of the battery cells 16 arranged next to each other to the predetermined section 28 of the temperature control channel 24 and the temperature control channel 24 widens again after the predetermined section 28.

Overall, the figures show an optimization of the temperature uniformity of a directly cooled cell battery module.

### LIST OF REFERENCE CHARACTERS

10 Motor vehicle
12 Electrical energy store
14 Cell block
16 Battery cell
18 Housing wall
20 Temperature control device
22 Temperature control fluid
24 Temperature control channel
26 Direction of flow
28 Predetermined section
30 Sealing plane
32 Base region
34 Top region
36 Central region
38 Sealing wall
40 Sealing wall
42 Temperature control fluid outlet
44 Temperature control fluid inlet

1.-10. (canceled)

11. A temperature control device (20) for controlling a temperature of a cell block (14) of an electrical energy store (14), comprising:
a temperature control channel (24); and
a temperature control fluid (22) which is guided in the temperature control channel (24) for controlling the temperature of the cell block (14), wherein the temperature control channel (24) has a changing cross-section viewed in a direction of flow (26) of the temperature control fluid (22) and wherein a plurality of battery cells (16) of the cell block (14) are disposed next to each other at least in areas viewed in the direction of flow (26);
wherein the temperature control fluid (22) directly controls the temperature of the cell block (14), wherein the temperature control channel (22) tapers in the direction of flow (26) from a first battery cell (16) of the plurality of battery cells (16) to a predetermined section (28) of the temperature control channel (24), and wherein the temperature control channel (24) widens after the predetermined section (28).

12. The temperature control device (20) according to claim 11, wherein the temperature control channel (24) is formed between a sealing plane (30) on the plurality of battery cells (16), which is formed in the direction of flow (26), and a housing wall (18) of a housing of the electrical energy store (12).

13. The temperature control device (20) according to claim 12, wherein the changing cross-section of the temperature control channel (24) is formed on the housing wall (18).

14. The temperature control device (20) according to claim 11, wherein the temperature control channel (24) is formed in an interior in a sealing plane (30) on the plurality of battery cells (16) and wherein the sealing plane is formed in the direction of flow (26).

15. The temperature control device (20) according to claim 14, wherein the sealing plane (30) has a first sealing wall (38) and a second sealing wall (40) opposite the first sealing wall (38), wherein the first sealing wall (38) and the second sealing wall (40) are formed in the direction of flow (26), and wherein the changing cross-section is formed on at least one of the first sealing wall (38) and the second sealing wall (40).

16. The temperature control device (20) according to claim 15, wherein the changing cross-section is formed on both the first sealing wall (38) and the second sealing wall (40).

17. The temperature control device (20) according to claim 11, wherein the predetermined section (28) is formed on the plurality of battery cells (16) viewed centrally in the direction of flow (26).

18. The temperature control device (20) according to claim 11, wherein the temperature control device (20) is formed for carrying out sheath temperature control and/or top temperature control and/or base temperature control.

19. The temperature control device (20) according to claim 11, wherein the battery cell (16) is formed as a prismatic battery cell and/or as a cylindrical battery cell and/or as a pouch cell.

20. A method for controlling a temperature of a cell block (14) of an electrical energy store (12) by the temperature control device (20) according to claim 11, comprising:
guiding the temperature control fluid (22) in the temperature control channel (24).
